(19) United States
(12) Patent Application Publication
(10) Pub. No.: US 2001/0051894 A1
(43) Pub. Date: Dec. 13, 2001

(54) INTERNET COUPON SELECTION SYSTEM

(75) Inventor: JAMES P. DELAPA, GRAND RAPIDS, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: AD RESPONSE MICROMARKETING, GRAND RAPIDS, MI (US)

(21) Appl. No.: 09/130,286

(22) Filed: Aug. 6, 1998

Related U.S. Application Data
(60) Provisional application No. 60/055,378, filed on Aug. 12, 1997.

(51) Int. Cl. G06F 17/60; G06F 15/16

(52) U.S. Cl. 705/14; 705/26; 709/203

(57) ABSTRACT

A merchandising system for generating product discount coupons preselected by each participating consumer. The process allows the consumer to select the coupons at home through a remote communication site, such as an Internet site. The selections are then electronically transferred to a specified store also chosen by the consumer. Upon arrival at the designated store location, the consumer receives the selected coupons, which are printed at the store by a kiosk or other form of printer. These coupons are immediately redeemable by the consumer during the current shopping trip upon purchase of the corresponding items.

This non-provisional application is based upon a U.S. Provisional Patent Application, Ser. No. 60/055,378, filed Aug. 12, 1997, and claims its priority date from that application, which is hereby incorporated herein by reference.

### BACKGROUND OF THE INVENTION

This invention relates generally to merchandising systems and methods and more particularly to systems for generating and redeeming consumer selected product discount coupons.

Historically, discount coupons have been delivered to the general public through various forms of mass distribution, including free-standing newspaper inserts and the like. Such distribution schemes, however, generally achieve a very low success rate. Presently only approximately 2.8 percent of coupons distributed are actually redeemed. This low rate is due to the fact that most of the coupons received by the consumers are for items not usually purchased by that particular consumer or that the consumer receives the distribution at a time when it is inconvenient for the consumer to think about and prepare for the next trip to the store. Either explanation results in at best a cursory review of the coupons before they are promptly discarded.

Recently, in an effort to improve the success rate of various coupon distribution schemes, micro marketing has developed to target the specific needs and common purchases of consumers and distribute to them coupons for those particular items. In order to accomplish this, information relating to each targeted consumer must first be accumulated. A common method first collects the relevant information by tracking the consumers' purchases through a retailer's electronic customer cards, and then distributes the coupons by mail. Although this approach results in an increase in the redemption rate of the coupons distributed, such an approach still fails to address the problem that the consumer will receive the coupons at an inconvenient time, and thus discard most or all of them. This approach also fails to address the possibility that the consumer may not even desire the coupons in the first place. Finally, many consumers feel that such an approach is intrusive of their privacy expectations and thus not desirable.

An additional concern with any of the mail distribution schemes is the possibility of fraud by the consumers or retailers. Currently, there is a significant misredemption rate of over 20 percent, resulting from misidentification of the coupons and fraudulent alterations or duplications of the coupons. The increase in fraudulent alterations has led many manufacturers to refuse to honor certain coupons that may be easily altered or copied, such as coupons distributed through the newspapers or the mail, or black and white coupons printed by a consumer's at home computer printer.

A variation to the micro marketing approach described above is to provide a focused coupon system, as detailed in U.S. Pat. No. 5,353,218 entitled FOCUSED COUPON SYSTEM. This system tracks each consumer's use of specific coupons delivered to their homes, and adjusts future coupon distributions accordingly. Additional purchasing information relating to each consumer may be acquired through telephone surveys or the like. This approach ensures that only coupons that are desired by a given consumer and are thus likely be used by the consumer are distributed, resulting in less waste. However, this system requires additional consumer information to be included in the bar code on the face of each coupon in order to properly track the usage of the coupons. While this specific bar code may assist in reducing fraud by consumers, it results in increased costs for the marketing scheme. In order to properly accumulate this information, additional processes must be established to scan the consumer specific information on coupons that are actually redeemed and coordinate such information with the consumer data acquired by the phone surveys.

Still yet another marketing approach is to allow consumers to select desired coupons from an Internet site before shopping at a particular store. The consumer can print out a list of the coupons and other offers that include a single bar code corresponding to the entire list. When the consumer later makes a purchase at the store, the bar code is scanned by the store's point of sale scanner and the discount amounts of any items purchased that correspond to items on the list are totaled. The consumer then receives a discount certificate equal to the total amount to be discounted. However, this certificate is not immediately redeemable with that transaction, but rather is for a discount on the consumer's subsequent purchases. Therefore, although this approach greatly reduces the fraud potential, it fails to provide the consumer with a discount on that particular purchase transaction. If the consumer loses the certificate before the next shopping trip, the discount is lost to the consumer.

### SUMMARY OF THE INVENTION

The present invention is intended to provide a coupon delivery system that distributes coupons that have been specifically requested by the consumer and distribute them at a time when the consumer is most likely to actually redeem them. This is accomplished by allowing the consumer to designate a preferred store and select desired coupons from a list of those available at that store, all while the consumer is still at home or work. The selected coupons are then made available to the consumer only upon the consumer's arrival at the designated store. This results in a distribution of only those coupons that each consumer is likely to redeem, at a convenient time when the consumer will actually use them, thereby greatly reducing the waste of unwanted coupons.

According to a first aspect of the invention, each consumer is identified through their retailer's electronic customer card number, or other store affiliated cards such as frequent shopping memberships or check cashing cards. The consumer, once identified, selects the desired store and the desired offers or coupons through a publicly accessible electronic communication site, such as an Internet site or the like. This site may be remote from the consumer, so that the offers can be selected from the consumer's home or office at any time prior to leaving for the store. Coupon selections are associated with the card identification number, so that when the consumer later presents the shopping card at the store, the appropriate coupons will be provided. Because the coupons are specifically requested by the consumer, the likelihood that they will be unwanted is greatly reduced.

A method according to another aspect of this invention is to print out the pre-selected coupons for the consumer upon arrival at the designated store. In order to provide such coupons in an efficient manner, a computer based kiosk is located at the retail store. The consumer is identified by the card number at the kiosk, which then promptly prints out the pre-selected coupons which the consumer can then immediately redeem upon purchase of the corresponding item, thereby reducing the possibility that the consumer will throw them out or misplace them prior to the next shopping trip.

Still yet another aspect of this invention is to print the coupons on color stock with a bar code identification that indicates to the store's point of sale scanner the appropriate amount to discount for the corresponding item. The coupons are printed on color coupon stock, with the selected store's logo and design thereon so that they are easily recognized by the store's cashiers, as well as by the product's manufacturer for redemption purposes. By printing the coupons in such a manner at the store, and only distributing them to the appropriate consumer, the possibility of fraudulent copying or altering is virtually eliminated.

These and other objects, advantages and features of this invention will become apparent upon review of the following specification in conjunction with the drawings.

### BRIEF DESCRIPTION OF THE DRAWINGS

FIG. 1 is a diagram of the various components, of a Internet Coupon Selection System according to the invention;

FIG. 2 is a block diagram of the selection process by the consumer;

FIG. 3 is a block diagram of the functions performed by the Communication Site;

FIG. 4 is a block diagram of the functions performed by the Store's Server; and

FIG. 5 is a block diagram of the coupon printing process as performed by the Kiosk at the specified store.

### DESCRIPTION OF THE PREFERRED EMBODIMENT

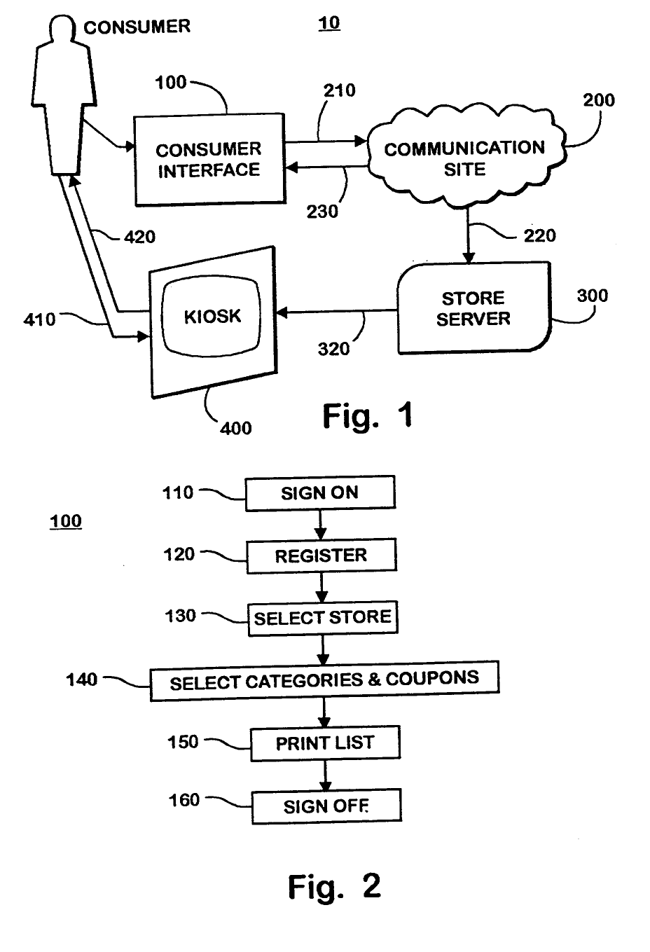

Referring now specifically to the drawings, a Internet Coupon Selection System 10 is shown in FIG. 1 and includes a consumer interface 100, an Internet server or other electronic communication site 200, a second server 300 located at a participating store's headquarters, and a kiosk 400 located at any participating store location. The system 10 is initially driven by a consumer operating the consumer interface 100, who establishes a communication link by signing on 110 to the communication site 200. Consumer interface 100 may be an in-home personal computer or other computer with access to the Internet or other electronic communications network. In the preferred embodiment, the communication link is connected via an initial link with a participating retail store's Internet site, but could alternately be a direct link between the consumer's computer and the communication site. Although the preferred embodiment is described herein as communicating on-line through various Internet sites, clearly such an embodiment includes any other means of communicating that is a publicly accessible electronic network, allowing the exchange of information from one site to another.

Although not critical to the scope of this invention, the following details the required consumer activities to complete the coupon selection process for the preferred embodiment. Clearly, this is a merely a means to generate the coupon selections, and other activities or requirements may be performed in alternate embodiments without affecting the scope of the present invention.

After the consumer interface 100 has established a link to the communication site 200, the consumer, as detailed in FIG. 2, must complete the sign on process. If new to the system, the consumer must first register 120 with the Internet Coupon Selection program. This merely entails entering information such as the consumer's name, password and E-mail address, along with a frequent shopper card membership identification number or a membership identification number from a similar program sponsored by the retail store, such as a check cashing card number. Following the initial registration 120, subsequent communications by the consumer will only require the consumer to enter the name and password associated with the identification number.

Upon completion of the sign on 110 and registration 120 processes, the consumer then selects the preferred store location 130 where the purchases will be made. In the preferred embodiment, because the link to the communication site 200 was made via the retail store's site, the consumer needs only to select the location of the desired store from an appropriate list. Alternately, if the link was established directly to the communication site 200, the retail store must first be input, then the desired location may be selected so as to access the appropriate coupons available. Once a particular store has been selected, a list of categories of consumer packaged goods and coupons available at that store will be viewable by the consumer, at which point the consumer may select those categories and coupons 140 that are desired. In the preferred embodiment, only those products for which coupons are currently being offered will be displayed, and the consumer may select as many of those as is desired. Upon completion of the selection process, a summary page will be displayed which lists the selected coupons and store location. When satisfied with the selections made, the consumer may sign off 160 from the communication site 200.

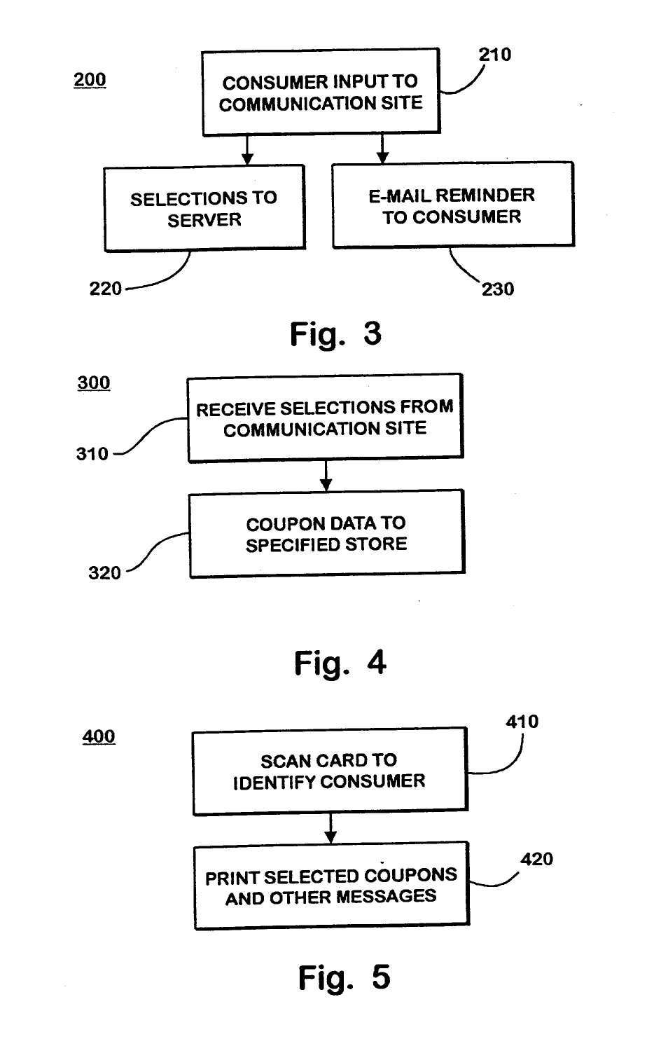

As detailed in FIG. 3, the software within the communication site 200 first receives the consumer input data 210 once the consumer signs off 160, and then transfers the coupon selections 220 with the consumer's identification number to a server 300 located at the retail store's headquarters or other appropriate location. Additionally, the communication site 200 of the preferred embodiment of this invention will automatically send an E-mail reminder 230 to the consumer detailing the list of selected coupons and store location where the consumer can pick them up and redeem them. Both the transmittal of the coupon selections 220 and the E-mail reminder 230 are performed immediately following the consumer's signing off 160. Upon receipt of the E-mail, the consumer may wish to print this list 150 on a personal printer or other accessible means for printing. Whether or not to print such a list is left at the discretion of the consumer because this is merely a list and not the actual coupons for the consumer to redeem. The communication site may also retain a record of the coupon offers selected for statistical purposes.

At the store's headquarters, the server 300 receives the consumer's selections 310 and immediately forwards the coupon data 320 to at least one kiosk 400, or other means for receiving such data and printing the coupons, located at the specified store location. The kiosks 400 may be located anywhere on the store's premises, preferably at each entrance to the store for easy access by consumers. Such a kiosk is disclosed in commonly assigned co-pending application Ser. No. 08/713,205 filed on Sep. 12, 1996, by DeLapa et al. for a COUPON DELIVERY SYSTEM, the disclosure of which is hereby incorporated herein by reference. The information transmitted to the kiosks includes the coupons selected by the consumer and the consumer's membership identification card number to ensure distribution of the coupons to the appropriate consumer. A participating store may have one or more kiosks 400 on its premises, and each one will receive the transmitted information. The coupon data is then stored in each kiosk 400 located at the particular store until the consumer retrieves them or until the coupons expire.

In order to receive the actual coupons requested, the consumer, upon arriving at the specified store, will scan his or her membership identification card 410 or similar card at one of the kiosks 400. The Internet selected coupons will begin to immediately print 420 at the in-store kiosk 400. In the preferred embodiment of this invention, the coupons are printed on color coupon stock with the store's logo, in order to prevent fraud by unauthorized duplications of the coupons. At the time that the coupons are printed, the store may also provide the consumer with additional coupons and messages pertaining to sales and promotions specific to that store. The software in the kiosks 400 may also maintain a record of the coupons actually released to the consumer's identification number for statistical purposes.

A significant advantage of this system is that once all of these coupons are printed for the consumer, they can be immediately redeemed during the consumer's current shopping trip. Because the kiosk 400 prints out the actual coupons, rather than merely a list or other summary information, this method does not require the consumer to make a second trip to the store in order to redeem the coupons for their face value. Furthermore, because the coupons are actually received by the consumer only at the time that the consumer is inside the store, preparing to purchase the products, this method will result in a much higher rate of redemption, without excess tracking of each consumer's buying habits and other statistics that many consumers feel are an invasion of their expectations of privacy. This results in a system that is more desirable to many consumers, without the excess tracking and mailing costs to the coupon providers.

Changes and modifications in the specifically described embodiments can be carried out without departing from the principles of the invention, which is intended to be limited only by the scope of the appended claims, as interpreted according to the principles of patent law.

The embodiments of the invention in which an exclusive property or privilege is claimed are defined as follows:

1. A computer implemented system for generating coupons to provide discounts for purchases of corresponding items including:
generating means for generating a list of coupons as selected by a consumer;
communicating means for communicating said list of desired coupons to at least one store; and
coupon printing means for printing a plurality of coupons corresponding to said list, said printing to occur at said store when requested by the consumer, said coupons being immediately redeemable upon purchase of the corresponding item.

2. The system of claim 1 wherein said generating means is through communications between the consumer and a site remote from the consumer.

3. The system of claim 2 wherein said site is a publicly accessible site.

4. The system of claim 2 wherein said site is an Internet site.

5. The system of claim 1 wherein said generating means includes designating a particular store and a particular store location for printing said coupons, said store and location being selected by the consumer.

6. The system of claim 1 wherein said generating means includes identifying the consumer by a membership identification number to a retail store's shopping program, said coupons being obtained by presenting said membership number to said retail store.

7. The system of claim 1 wherein said coupon printing means is a printer that prints said coupons on color coupon stock with a bar coded identification thereon, in order to prevent fraud or duplication of said coupons.

8. The system of claim 1 further including a second communicating means to communicate a reminder message including said list of coupons to the consumer.

9. The system of claim 8 wherein said second communicating means communicates to the consumer via an e-mail message to the consumer.

10. The system of claim 1 further including list printing means for printing said list of coupons, so that the consumer retains a copy of said list prior to requesting said coupons at said store.

11. The system of claim 1 wherein said coupon printing means is a kiosk located at said store.

12. The system of claim 11 wherein said kiosk is located at an entrance to said store.

13. The system of claim 11 wherein said kiosk scans a consumer's shopping membership card in order to identify the consumer and provide corresponding coupons thereto.

14. The system of claim 11 wherein the consumer receives said coupons and additional information and in-store coupons as supplied by said designated store from said kiosk.

15. The system of claim 5 wherein said store has a headquarters, said list of coupons being communicated to a server at said headquarters, said server further communicating said list of coupons and additional store information and coupons to said particular location so that said coupons are available to the consumer upon arrival at said location.

16. A computer implemented method of generating coupons to provide discounts for purchases of corresponding items including:
generating a list of coupons with a computer that receives a selection of coupons from a consumer;
communicating with a computer said list of coupons to at least one store;
printing a plurality of coupons corresponding to said list of coupons with a printer at said store, said coupons being immediately redeemable by the consumer at said store upon purchase of the corresponding item.

17. The method of claim 16 wherein said list of coupons is generated through communications between the consumer and a site remote from the consumer.

18. The method of claim 17 wherein said site is publicly accessible.

19. The method of claim 17 wherein said site is an Internet site.

20. The method of claim 16 further including designating a particular store and a particular store location for printing said coupons, said store and location being selected by the consumer.

21. The method of claim 20 wherein said particular store is designated through communications between the consumer and a site remote from the consumer.

22. The method of claim 16 wherein the consumer is identified by a membership identification number to a retail store's shopping program, said coupons being obtained by presenting said membership number to said retail store.

23. The method of claim 16 wherein said coupons are printed by a printer that prints said coupons on color coupon stock with a bar coded identification thereon, in order to prevent fraud or duplication of said coupons.

24. The method of claim 16 further including communicating a reminder message including said list of coupons to the consumer.

25. The method of claim 24 wherein said reminder message is communicated to the consumer via an e-mail message to the consumer.

26. The method of claim 16 further including printing said list of coupons, so that the consumer retains a copy of said list prior to requesting said coupons at said store.

27. The method of claim 16 wherein said coupons are printed by a kiosk located at said store.

28. The method of claim 27 wherein said kiosk is located at an entrance to said store.

29. The method of claim 27 further including scanning a consumer's shopping membership card at said kiosk in order to identify the consumer and provide said plurality of coupons thereto.

30. The method of claim 29 wherein the consumer receives said coupons and additional information and in-store coupons as supplied by said designated store from said kiosk.

31. The method of claim 20 wherein said store has a headquarters, said list of coupons being communicated to a server at said headquarters, said server further communicating said list of coupons and additional store information and coupons to said particular location so that said coupons are available to the consumer upon arrival at said location.

32. A computer implemented method of generating coupons to provide discounts for purchases of corresponding items including:
identifying a consumer by a shopping membership card number corresponding to the consumer;
generating a list of coupons and a designated store with a computer that receives a selection of coupons and store from the consumer;
communicating with a computer said list of coupons to a kiosk at said designated store;
scanning the consumer's membership card at said kiosk; and
printing a plurality of coupons corresponding to said list of coupons with a printer at said kiosk, said coupons being printed on color coupon stock with bar coded identification to prevent fraud and duplication of said coupons, said coupons being immediately redeemable by the consumer at said store upon purchase of the corresponding item.

33. The method of claim 32 wherein the consumer enters said membership number, store location, and selected coupons through communications with an Internet site.

34. The method of claim 32 wherein said store has a headquarters, said selected coupons are first communicated to a server at said headquarters, said coupons then communicated to said designated store along with additional store specific coupons and messages.
